(19) United States
(12) Patent Application Publication
(10) Pub. No.: US 2022/0182251 A1
(43) Pub. Date: Jun. 9, 2022

(54) SYSTEM AND METHOD FOR BI-DIRECTIONAL COMMUNICATION FOR PERFORMANCES

(71) Applicant: Pythia Visions, LLC, Charlottesville, VA (US)

(72) Inventor: Andrea Gibb JACOBS, Arlington, VA (US)

(21) Appl. No.: 17/541,910

(22) Filed: Dec. 3, 2021

Related U.S. Application Data
(60) Provisional application No. 63/121,785, filed on Dec. 4, 2020.

(51) Int. Cl. H04L 12/18; H04N 7/15

(52) U.S. Cl. CPC H04L 12/1822; H04N 7/155; H04L 12/1831

(57) ABSTRACT

A system and method for bi-directional communication for performances include an interface for receiving and displaying a performance to at least one user. The user may respond to the performance through the interface including a contribution such as an image, a recording, or a text-based message. The performer may receive the response from the at least one user. The system and method further generate a mosaic of user responses to the performance determined based on recency, popularity, or randomly. The mosaic may be displayed on the display behind the performer, who may be performing in front of a green screen.

### FIELD OF THE DISCLOSURE

The present disclosure relates to a system and method for bi-directional communication in performances, particularly live performances and dynamic performances.

### BACKGROUND

Concerts, live performances such as talk shows, and other entertainment like television shows, movies, and musical performances, are ordinarily performed or broadcast to audiences with little to no feedback or understanding on whether or why the audience engaged with the performance. While audiences at a live concert, for instance, may cheer or applaud loudly for certain numbers or acts that the audience members enjoy, there is no way to understand the individual reasons for audience members' engagement with the artist.

Concertgoers currently have no way to connect with the audience as a whole. While individual concertgoers may become acquainted with other individual members of the audience, no functionality allows the concertgoers to meaningfully participate with the performers (to communicate their preferences) or to connect with numerous other concertgoers in real-time or substantially real-time or following the performance.

Similarly, with television ratings, while people may tune in to a program in greater numbers when they enjoy it, resulting in higher ratings, there is no way outside of manually conducted and inherently subjective focus groups to tease out people's reasons for tuning in. Artists and performers who attempt to replicate the success of a popular song, TV series, or other performance must surmise the reason for the success of the performance, often without success.

The production of movies and TV shows involves the use of writing rooms, sets, and music production that are entirely detached from the preferences and feedback of the audience. Therefore, writers and producers must gamble on a script, score, and set design without knowing how the audience responds. Further, because the audience has no role in the production decisions, the audience members are at the mercy of the writers and producers to tell stories that will resonate with and enrich the audience. Film sampling with test audiences and market surveys are primitive approaches that comprise a decades-old approach to ascertain viewer responses. Moreover, these methods are expensive, inaccurate, and time-consuming and do not allow bi-directional communication but rather only extract information from participants without engaging with the writers, producers, studio, etc.

Story development is the iterative process of developing characters, backgrounds, motives, interpersonal relationships, surrounding environment, key events within a historical period, and unresolved and resolved conflicts. In this creative process, hundreds of writing decisions create millions of future branches in the same story. Each of these decisions has the potential impact to make or break a story's success.

Much like anticipating potential moves in a chess game, the permutations rapidly outgrow the human mind's capabilities. But without the input of audience members to assess the audience's response to particular writing decisions, studios are flying blind on writing material that will resonate with audiences and ultimately generate revenue. Given the importance of writing material that audiences will appreciate and the absence of modalities for bi-directional communication, there is significant room for improvement in how studios approach the creative process.

Artists who wish to collaborate with fans to create new art have no way to do so. Rather, existing methods require contributors to rely on exclusive networks established in the industry to submit creative ideas or feedback. There is a need for a creative studio space, such as a virtual studio, that allows artists and fans to freely and easily collaborate and communicate bi-directionally to incrementally and modularly develop new art, including music, storylines, dialog, sets, and otherwise.

With the COVID-19 pandemic's effects on live concerts and other performances, there is an increase of online video conferencing modalities such as Zoom, Skype, and others. While these video conferencing services may allow a user to communicate with remote participants using video and audio, no existing modality allows users to communicate their preferences, such as regarding a subsequent song or performance, to a performer. There are no systems or methods for online concerts that facilitate bi-directional communication that provides comments (as with Facebook live videos) and quantifiable and easy-to-access feedback from the users upon which the performer can rely. There is a paucity of options for users to simulate concert experiences in an emotionally engaging way remotely. Audiences have no choice but to sit and listen passively.

In short, there are no existing systems or methods that involve the potential audience of a presentation or performance in the creative process, which is a disadvantage to the audience because the quality of the performance is suboptimal and a disadvantage to the performer as the performer is unable to tailor their performance and craft to the demands of the audience. There is no way to “break the fourth wall” between the performer and the audience, particularly when the audience is scattered around the world and is accessible only through video conferencing.

Given the foregoing, there is a need for a system and method for bi-directional communication in performances that allows an audience member to communicate their preferences, ideas, and responses to the performance to the performer, before, during, and following the performance.

### SUMMARY

The problem of existing performance experiences and video conferencing modalities being unable to facilitate bi-directional communication that allows a performer, writer, producer, or another person to “break the fourth wall” to receive and adapt to the feedback and preferences of audience members is addressed by embodiments of the system and method for bi-directional communication of the present disclosure. The system and method for bi-directional communication for performances advantageously provides an interface including in embodiments a screen for displaying a performance, including a performer, to one or more audience members or users. The interface may also provide the users with modalities for connecting to the performer and other users.

For example, the system and method may create user profiles that allow users to post and save contributions and engagements, such as feedback, in response to a performer or other user. The profile may define a timeline of contributions and engagements indexed according to particular performances, such as online concerts.

A home screen of the system's interface may display a schedule of live, previous, and upcoming events that a user may scroll through, view, select, and register for. The home screen selections may be automatically selected for each user based on the user's followed performers, previously attended performances, user profile, demographic data, or any other suitable factor.

A user may select from a predetermined selection of performances through the interface, showing previous, live, and upcoming performances. The user may view past performances and the contributions submitted in response to it by other users, join in live performances and contribute to them, or register for upcoming performances and observe contributions submitted in anticipation of the upcoming performance. The performances may be online concerts, TV shows and miniseries, choose-your-adventure-type performances, and others.

The system may indicate to a user when access to an upcoming performance is becoming limited, i.e., selling out, and may indicate when a deadline for registering for the upcoming performance will expire. The user may purchase access to the performance through the interface through a suitable or standard payment portal.

A pre-performance component of the system may allow users to prepare for an upcoming performance by showing, for example, a countdown timer to the start of the performance. The interface may link the user to profiles of performers and sponsors as the user waits for the start of the performance. The links to the profiles of performers may allow the user to see other performances scheduled by the performer or contributions relating to other performances by the performer, follow the performer, and register for attendance in other performances. The pre-performance component or portal may also link the user to products or services provided by or for the performance and from sponsors.

The interface may show and link the user to contributions by other users, which may take photos, text, audio recordings, video recordings, or otherwise. Likewise, the interface may allow the user to contribute by submitting real-time captured or previously captured photos, text, audio recordings, video recordings, or other forms of engagement.

The interface allows the user to engage with other users' contributions by starring or liking the contribution, viewing the profile of a user who shared a particular contribution, or flag/report a contribution that violates one or more community guidelines of the system. The system may utilize an automated text moderation system that automatically filters and removes contributions that violate a community standard. The system may similarly utilize an automated photo moderation system. The contributions may be clicked to instantiate a popup screen that shows the contribution, hovered over to instantiate a popup screen that shows the contribution or clicked to navigate to the contribution as shown on the contributing user's profile.

The contributions from the user and other users may be shown in a shares or contributions section of the interface and may take the form of a grid, a rolling feed, or another suitable form. In embodiments in which the contributions section is a grid, the grid may be paginated, allowing users to load another page of contributions after observing the first page of contributions. The new page of contributions may be added to the first page or replace the first page.

The interface may allow a user to engage with a sponsor of a performance by instantiating, for example, a webpage linking to the sponsor when the user clicks on, hovers over or otherwise engages with a sponsor banner, ad, or contribution. In embodiments, when the user hovers over a sponsor ad, a popup window is instantiated over the interface, automatically closed when the user is no longer hovering over the ad.

When the contributions assume a grid configuration, a first, i.e., the top-left grid, may rotate through sponsor ads, such that the ads will be readily visible to a user as they begin to peruse the contributions section. In embodiments, a sponsored ambassador may be assigned a user profile that can engage with the performer and other users just like a normal user. The sponsor ambassador may post contributions such as images, videos or otherwise populate the contributions section in real-time with other users' contributions.

The interface may be configured to allow a user who wishes to share an image or video recording in real-time by facilitating an image-capture functionality. The image-capture functionality may use a camera and microphone integrated with the user's device, such as their smartphone. Otherwise, users may upload an image, video, or audio recording from their smartphone gallery or computer.

During the performance, the interface may be configured to solicit, receive, and transmit feedback from one or more users who define the audience to one or more performers, such as lecturers teaching a class, musicians putting on a concert, comedians performing a stand-up routine, talk-show hosts interviewing a celebrity, politicians or business leaders conducting a press conference or participating in a debate, or otherwise. For example, the interface may present questions to the users regarding the users' preferences for a next song to sing, a topic to discuss, a question, or otherwise. The questions may take the form of short answer text responses, multiple-choice responses, or otherwise. The feedback may be shown or “pushed” to the performer in real-time or substantially real-time, allowing the performer to adapt to the user's preferences.

For example, to determine which of a performing artist's songs the users would like to hear next, a limited selection of possible songs may be provided through the interface in a multiple-choice format. The users may provide their feedback by selecting one or more possible songs, and the interface may show the performer the responses. For example, if a majority of the users select a particular song, the performer may pivot and adjust their intended routine to accommodate this feedback from the users. To determine which possible topics a talk-show host should ask the interviewee about, users may provide their feedback using, for example, a text response, from which a word cloud may be generated, indicating to the host the most-desired topics.

Users who provide such feedback in a predetermined amount, such as a certain number of times during a particular performance, may earn “badges” displayed on the user's profile. The user's profile may include a username, a name, an about section comprising up to 100 characters of self-description, a matrix or list of the user's contributions, possibly organized in a timeline, and a passport showing badges earned during performances. The user profile may include a function for nested responses to the contributions in the matrix or list of the user's contributions, such as photos, comments, video or audio recordings, or otherwise.

In an embodiment, contributions from one or more users may be automatically compiled into a mosaic of contributions in real-time or substantially real-time during or after a performance. For example, a performing musician may perform in front of a green screen, with the mosaic of contributions shown behind the musician during the performance. This advantageously allows the user to be part of the performance; for example, if the user contributes a selfie incorporated into and shown in the mosaic behind and around the performer. The contributions selected for displaying on the green screen may be selected, for example, based on popularity (e.g., the number or percentage of other users who have starred the contribution), based on recency, randomly, as a reward earned by a user, based on a user's status or ranking, manually by a show manager or performer, or by any other suitable determination.

The system may be configured to make the mosaic unique to each user and always shows the user's contribution(s) in the mosaic. In other embodiments, the mosaic may be the same for a plurality of users, such as based on geographic location or another characteristic common to the plurality of users. While the mosaic has been described as being displayed behind a performer on a green screen, the mosaic may also be shown to the user solely on the interface. The mosaic advantageously provides a space for users to star other users' contributions, such as photos, and if desired, communicate directly with another user after being introduced by seeing the other user's contributions as displayed in the mosaic.

The system may select the individual components of the mosaic chronologically, at random, or may determine the components based on popularity, such as by the number or percentage of other users who have starred the contribution. In embodiments, the mosaic may be dynamic and change to replace older/existing contributions with newer/different contributions in any suitable manner, such as after a predetermined amount of time, at random, or otherwise. The system may rotate out older or less relevant contributions in a uniform manner, such as from the bottom row of the mosaic and simultaneously, or from seemingly random locations in the mosaic and a chronologically staggered manner.

In other embodiments, the mosaic may be static such that after the mosaic has been determined and generated from contributions, the mosaic does not change for the rest of the performance. The system may be configured to determine the mosaic to maximize the diversity of contributions, such as culling redundant text contributions or selecting selfies from users having variegated demographic information in their bios, such as by age, gender location, stated interests, or otherwise. The system may also draw upon contributions from previous performances by the performer. Users whose contributions are included in the mosaic may, in embodiments, receive a predetermined percentage of revenue from the performance.

The mosaic may be saved such that after a performance has concluded, the mosaic may be saved, downloaded, displayed, or otherwise accessed by users or others as its own artistic and journalistic representation of the performance. The system may be configured to automatically configure the mosaic from images of a plurality of user contributions such that the images together define a photographic mosaic. The system may be configured to define the photographic mosaic in any suitable way, such as to define an image of the performer, a logo, or any suitable image. The system may further be configured to automatically apply one or more filters or adjustments to the contributions such that the mosaic defines the desired color scheme, for example.

The mosaic may be searchable in real-time or after the performance. The interface may provide a search bar or other search functionality about or over the mosaic such that users may search for who else has contributed to the mosaic or for a specific contribution. The mosaic may also be filtered to show only what users have starred or contributed themselves.

The system and method embodiments may be configured to record the performance and all user engagement to allow users who participate in or view a performance not live but rather after the fact to experience the performance substantially as if it was in real-time, by replicating the influx of contributions from other users at a corresponding time of the recorded performance. The mosaic as displayed to a user participating after the fact may likewise be updated for the user such that the user's contributions are added to the previous contributions from other users as though in real-time. The user's responses to prompts may likewise be shown with other users' previously recorded responses as though the other users were participating in real-time.

An individual user's contributions over time and across different performances may be cataloged in a timeline accessible through or as part of the user's profile, allowing review and observation of the contributions by the user themselves or by other users at any desired level of granularity. For example, the user's timeline may be viewed for a single performance which may comprise multiple contributions or engagements by the user. The user's timeline may be viewed for a single performer of a multi-performer performance, such as the user's contributions to or engagements with the headlining artist instead of the opening artist. The timeline may be organized to show the user's contributions throughout an ongoing multi-performer performance, such as a concert featuring multiple bands or performing artists in succession.

An example of a multi-performer performance to which the system and method embodiments are adapted includes a multi-performer performance in which the performances are categorized and conducted according to the basic acts of a storytelling arc, including in sequential order: exposition, rise, climax, fall, and resolution, such that the prompts and reflections provided in response to it may correspond to the pertinent storytelling arc act. In embodiments, the multi-performer performance may play out at different times, each time corresponding to one or more of the basic acts, respectively.

The system and method may be configured to allow a sponsor to engage with users by offering products and services in a pre-performance component of the interface, by prioritizing a component or area of the mosaic during the performance to show an engageable ad or logo for the sponsor, by automatically identifying contributions by users during the presentation that pertain to the sponsor, such as by utilizing a hashtag or sharing the sponsor's content on a user's profile, by engaging directly with customers after the performance, such as by offering sponsored event merchandise to users who shared or contributed sponsor-related content and by allowing a sponsor to offer specialty plans or offerings to users based on each performance. Sponsor ads may be played on the interface in the pre-performance component of the interface.

Alternatively, the user's timeline may be viewed grouped by months, years, performing artists, or otherwise. For example, the interface may allow a user to filter the timeline to see how a user engages with a particular band or has generally engaged with music performances, such as over the past year. The interface may provide or define a scale that allows the user to easily scale from a close-up view, such as a single performance, to a high-level view, such as an entire year or years.

The timeline may be configured to display publicly the contributions that a user has made to performances in groups or circles of users. The timeline may also be configured to display privately the reflections that a user has to questions or prompts provided by the system through the interface. Whereas the contributions may be spontaneous and user-directed, the reflections may be provided by the user in response to predefined or administered prompts, for example, by a show manager or by the system automatically. The prompts may be configured to engage the user with the underlying narrative structure of the performance to elicit narrative responses from the user that corresponds to a predefined narrative arc.

Reflections may be solicited from users by providing timed questions through the interface. The questions may be predetermined and set by a show manager, by the system automatically, by the performer, or otherwise. The reflections are chosen and organized to observe users' responses to the performance, generate a graph or other analysis based on the responses, and transmit the responses to, for example, the show manager. The users' responses may be analyzed and collated into a word cloud showing the predominant themes, ideas, and emotions elicited in response to the performance. The analysis may be dynamic, such that a first analysis is generated in response to a first act or routine of a performance, a second analysis is generated in response to a second act or routine, and so on. The analysis of the responses to the reflections may be shown only on an interface of the show manager panel rather than on any user's profile or timeline, thus preserving the anonymity of the responses.

The system may facilitate community engagement by facilitating private messages, group chats, and performance-specific circles. This allows users to connect based on specific interests, including participation in the same performance and based on a specific contribution, such as a text, image, or recording. By creating private messages, group messages, and circles, including users who participated through the system in the same performance, audience members can meaningfully connect and share experiences while more closely simulating the in-person concert experience. This allows for the system to provide the benefits of controlled, online collaboration and communication and the excitement and novelty of in-person events while minimizing the inherent drawbacks of online and in-person engagement.

The system and method of embodiments may support or define a show manager panel and a performer panel. Whereas the user interface may show a video image of performance and contributions by users and sponsor ads, the system may define a separate interface for a show manager. The show manager may be an individual selected to filter a performer's messages during the performance itself. For example, the show manager may be employed by the performer. The show manager may observe the performer within a screen and instruct the performer through a messaging interface to move in a particular direction to stay properly framed within a camera field of view.

In embodiments, the show manager may receive the feedback from the users and selectively push the feedback to the performer, such that the performer can see that the users have decisively voted on a particular song to be performed next, for example. The system may automatically give preference to prodigious users, e.g., users who engage more frequently than others, such as by a predefined threshold. Such users may be termed “superfans” whose feedback and contributions receive preferential treatment, such as being suggested for being pushed directly to the performer for a shout-out or being included in the mosaic shown on the green screen. Superfans may be so defined based on engagement generally across performances available on the system or the basis of a single performer or genre. Such superfans' profiles may choose to have their profiles be publicly visible to other users.

The show manager panel may include an interface that shows one or more user contributions posted during or in response to the performance. The contributions may be arranged as a matrix or shown one at a time in this interface, based on a selection by the show manager. Alternatively, the show manager may specify whether the interface shows user contributions (public) or reflection responses (private).

The show manager panel may further show reflection responses to the prompts, with the responses automatically transformed to graphs, word clouds, or otherwise. This may inform the show manager what recommendations to make to the performer, such as through the messaging portal of the show manager panel. The system may be configured to highlight most-starred contributions for the show manager's attention and review. The show manager may have the option through the show manager panel to create custom prompts for reflections in real-time, such as in response to ongoing contributions or due to the changing performance dynamics. Alternatively, the show manager may rely on a predetermined schedule of prompts.

The performer panel may support or define an interface specific to a performer in embodiments. The performer interface may include a screen showing the performer within the camera field of view, such as in front of a green screen, and one or more applications allowing the show manager or the system to push feedback from the users to the performer. The performer panel may include a messaging interface that shows messages received directly from the show manager or the system, instructing the performer to situate themselves differently within the field of view.

The performer panel may include an interface that shows particular user feedback pushed to the performer panel. This may be graphical results of a multiple-choice question regarding which song a plurality or majority of users wish to hear next. The performer panel may include an interface showing one or more user contributions, with a link to the user's username and the contribution, such as the image itself. The performer panel may include an interface allowing the performer to see individually selected contributions, such as selfies, videos, or otherwise, annotated with the user's username and name so that the performer can give a shout-out to a particular user.

An admin panel of the system and method may facilitate the addition of events, sponsors, users, and prompts to be pushed automatically during a performance. The prompts may be scheduled to be pushed to and visible for predetermined times and durations before, during, and after a performance. An admin, such as a show manager or otherwise, may step through and select from existing sponsors, existing or previous prompts, existing or previous reflections, and existing or previous contributions when setting up an event. The reflections may be organized into blocks corresponding to a time when a reflection prompt was shown or sent to users.

The system and method of embodiments may be configured to facilitate a co-creative experience between a user or plurality of users and a performer, writer, producer, or otherwise. The system may be configured to provide a live question and answer session with a host of a show, such as a talk show, a TV show, or other performance, thus allowing the users to ask questions and provide feedback to the host. The interface may provide a field for typing a question that will be pushed to a show manager or system administrator, which may be manually or automatically assessed before pushing the question to the performer.

This arrangement allows users to help write a TV show. For example, a 10-episode stretch of a TV show may be pre-written and pre-recorded for being viewed through the system.

The system allows users to provide feedback throughout the ten episodes and submit suggestions, questions, and preferences for story arcs that can be used to write additional episodes, such as the next two episodes.

The feedback may be provided through short answer text responses shown to the writers as a word cloud, multiple-choice questions that the user may respond to, and which responses are collated into graphs, or questions submitted by the user to the writers. This bi-directional communication system allows writers and producers to provide a pleasing narrative experience to the users based on real, quantifiable feedback, avoiding the tragedy of popular shows like Game of Thrones that have poorly crafted and universally disliked endings leave entire fanbases in an uproar.

According to embodiments of the present disclosure, a virtual studio may utilize a bi-directional communication system and method such that users may collaborate directly with writers, artists, and producers to produce a synergistic creative experience and facilitate a direct connection between the performers the viewers. The system may be configured to prompt a performer to share the first iteration of a storytelling act, such as an episode of a show where the episode corresponds to a storytelling component, provide prompts to the users with the first episode and receive responses from the users, and collate the users' responses so that the performer can respond accordingly. The virtual studio thus may facilitate a seamless connection between a live music environment and a user's home environment by providing an interface in which a user may draw upon performance and add comments and ideas thereto, this bi-directional communication defining a feedback loop between performer and viewer that allows for the co-creation of improved media.

In embodiments, the system and method provide for an automatic storytelling generator in which a user may insert their likeness into a storytelling arc through the interface of the system, such as a comic book-type story. The user may select the desired story structure from a menu of predetermined stories, upload an image that the system automatically converts to an animated format, and select a layout, backdrop, dialog, and other storytelling components.

The virtual studio may further facilitate the creation and solicitation of custom, modular storytelling components directly by users and as collaborations of users. In an embodiment, the system provides an interface allowing a user to modularly compile a soundtrack, including instrumentals, vocals, additional tracks, and effects.

The system may be configured to provide a more equitable revenue-sharing arrangement between artists, producers, and users. As users submit ideas or contributions incorporated into a performance, such as a photo used in a mosaic forming a backdrop of a musical performance, the user may receive a predetermined percentage of the revenue from the show. Likewise, artists may receive a larger percentage of revenue given the lower overhead cost of performing and the lower cost and inconvenience—and therefore greater availability—of participation for users.

These and other disclosure features will become better understood regarding the following description, appended claims, and accompanying drawings.

### BRIEF DESCRIPTION OF THE DRAWINGS

FIG. 1 depicts an interface for bi-directional communication for performances according to an embodiment.

FIG. 2 depicts an interface for bi-directional communication for performances according to another embodiment.

FIG. 3 depicts an interface for bi-directional communication for performances according to another embodiment.

FIG. 4 depicts an interface for bi-directional communication for performances according to another embodiment.

FIG. 5 depicts an interface for bi-directional communication for performances according to another embodiment.

FIG. 6 depicts an interface for bi-directional communication for performances according to another embodiment.

FIG. 7 depicts an interface for bi-directional communication for performances according to another embodiment.

FIG. 8 depicts an interface for bi-directional communication for performances according to another embodiment.

FIG. 9 depicts an interface for bi-directional communication for performances according to another embodiment.

FIG. 10 depicts an interface for bi-directional communication for performances according to another embodiment.

FIG. 11 depicts an interface for bi-directional communication for performances according to another embodiment.

FIG. 12 depicts an interface for bi-directional communication for performances according to another embodiment.

FIG. 13 depicts an interface for bi-directional communication for performances according to another embodiment.

FIG. 14 depicts an interface for bi-directional communication for performances according to another embodiment.

FIG. 15 depicts an interface for bi-directional communication for performances according to another embodiment.

FIG. 16 depicts an interface for bi-directional communication for performances according to another embodiment.

FIG. 17 depicts an interface for bi-directional communication for performances according to another embodiment.

FIG. 18 depicts an interface for bi-directional communication for performances according to another embodiment.

FIG. 19 depicts an interface for bi-directional communication for performances according to another embodiment.

FIG. 20 depicts an interface for bi-directional communication for performances according to another embodiment.

FIG. 21 depicts an interface for bi-directional communication for performances according to another embodiment.

FIG. 22 depicts an interface for bi-directional communication for performances according to another embodiment.

FIG. 23 depicts an interface for bi-directional communication for performances according to another embodiment.

FIG. 24 depicts an interface for bi-directional communication for performances according to another embodiment.

FIG. 25 depicts an interface for bi-directional communication for performances according to another embodiment.

FIG. 26 depicts an interface for bi-directional communication for performances according to another embodiment.

FIG. 27 depicts an interface for bi-directional communication for performances according to another embodiment.

FIG. 28 depicts an interface for bi-directional communication for performances according to another embodiment.

FIG. 29 depicts an interface for bi-directional communication for performances according to another embodiment.

FIG. 30 depicts an interface for bi-directional communication for performances according to another embodiment.

FIG. 31 depicts an interface for bi-directional communication for performances according to another embodiment.

FIG. 32 depicts an interface for bi-directional communication for performances according to another embodiment.

FIG. 33 depicts an interface for bi-directional communication for performances according to another embodiment.

FIG. 34 depicts an interface for bi-directional communication for performances according to another embodiment.

FIG. 35 depicts an interface for bi-directional communication for performances according to another embodiment.

FIG. 36 depicts an interface for bi-directional communication for performances according to another embodiment.

FIG. 37 depicts an interface for bi-directional communication for performances according to another embodiment.

FIG. 38 depicts a system diagram according to an embodiment of the present disclosure.

The drawing figures are not necessarily drawn to scale but instead are drawn to understand the components better and are not intended to be limited in scope but to provide exemplary illustrations. The figures illustrate exemplary configurations of a system and method for bi-directional communication for performances and in no way limit the structures, configurations, or methods of a system and method for bi-directional communication for performances according to the present disclosure.

### DETAILED DESCRIPTION OF VARIOUS EMBODIMENTS

The embodiments of a system and method for bi-directional communication for performances address the problems of existing methods and modalities for performances, including live concerts, in-person talk shows, political events, and entertainment such as TV shows, movies, and others being unable to involve a potential audience in the creative process. The system and method embodiments advantageously allow a user to submit real-time feedback to a performer, yielding a performance that better meets the audience's needs.

The embodiments may be implemented to overcome many technical difficulties and computational expenses associated with communicating between performers and viewers. The embodiments provide a system and method for co-creating performances such as artistic performances by involving users in the creative process, rather than existing methods of relying upon previously conducted focus groups to indicate what consumers want. By providing the system and method for bi-directional communication for performances according to the embodiments, a performance-, performer-, and user-specific interface may be defined for more efficiently presenting a performance and soliciting meaningful feedback in response.

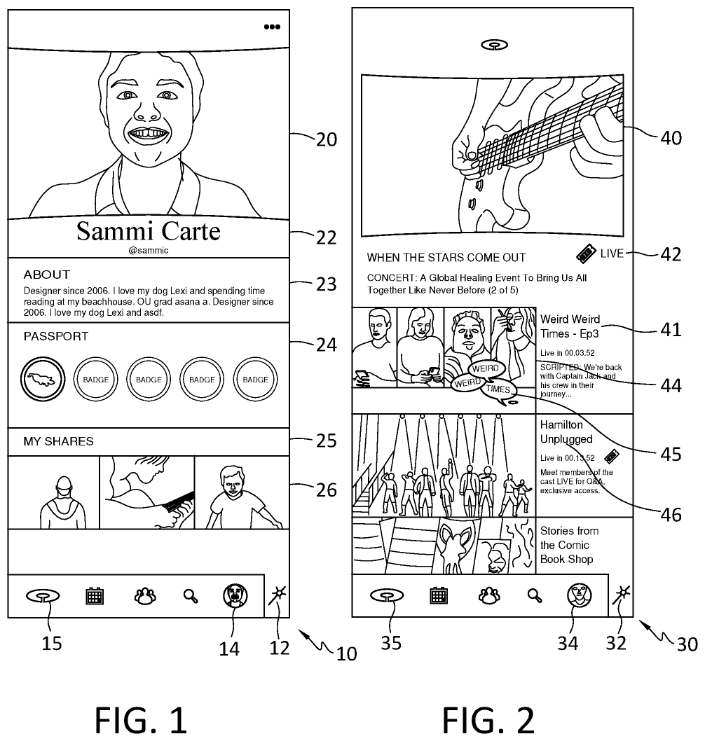

FIG. 1 depicts a user profile defined by an interface 10 of an embodiment of a system for bi-directional communication for performances. Interface 10 may be shown on a screen 12, which may be a touchscreen of a mobile device or a screen of a personal computer. The interface 10 may comprise a menu bar 14 including one or more clickable icons 15, which may navigate respectively to a home screen, to a calendar or listing of upcoming performances, to a messaging or community portal, to a search function, and to a user's profile.

The user profile may include a cover image 20, user information 22 such as the user's name and a specified username, an about section 23, which may be limited to a certain number of characters, a passport section 24 where badges earned by contributing to performances may be displayed, a certain number, type, or combination of badges indicating a user's “superfan” status, as well as to a contribution section 25 wherein individual contributions 26, such as images, text-based messages, video or audio recordings, or other contributions may be recorded and shown. In the depicted embodiment of FIG. 1, contributions 26 are arranged in a matrix or grid, but contributions 26 may be shown in any suitable arrangement in other embodiments.

FIG. 2 shows an interface 30 defining a performance listing of a system for bi-directional communication for performances according to an embodiment. The interface 30 may be shown on a screen 32 and may, as with the user profile, comprise a menu bar 35 showing one or more icons 35 for navigating the system. The interface 30 may include a headlining performance 40 and indicia 41 showing information about the performance, including a title and description. A status indicator 42 may show whether a show is lived, scheduled, or past performance. Additional performances 44 may be shown in a listing beneath the headliner performance 40, the listing taking any suitable format such as a matrix, list, grid, or otherwise. The listing may include images or videos 44 relating to the performances and information 45, such as descriptions, titles, admission prices and statuses, and dates for the performances. The user may scroll through the listing to find performances to engage.

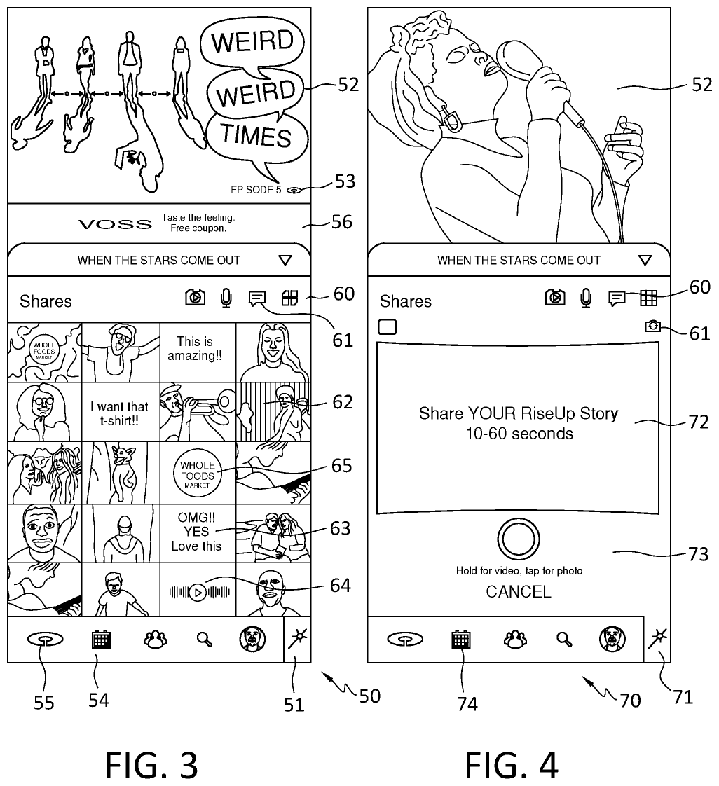

FIG. 3 shows an interface 50 on a screen 51 over which a menu bar 54 with icons 55 may be overlaid, the interface 50 about a performance. The user may view the performance 52 at one portion, such as the top, of the screen 51, with information 53 regarding the performance shown overlaid as suitable. In embodiments, a sponsor banner ad 56 may be arranged proximate the performance 52. The banner ad 56 may rotate between different sponsors, be static and/or customized to a user's preferences based on the user's contributions and engagements.

The interface 50 advantageously defines a contribution section 60. The contribution section 60 allows the user to provide real-time feedback during the performance. It will be understood that the feedback is considered real-time if it is provided or observed while the user is observing the performance, which may have been pre-recorded or may be occurring live. Additionally, the feedback may be provided or observed in anticipation of a scheduled performance before it has taken place. That is, the contribution 60 may be open for an event in a pre-performance mode, such that users may post contributions in anticipation of an upcoming performance.

The contribution 60 may include individual contributions by a plurality of users. The user's interface 50 may preferentially show the user's contributions in the contribution section 60, which may be arranged in a grid or matrix as shown or may be a listing, a continuously scrolling feed, or any other suitable arrangement. The user may post their own contribution by using icons 61, which may correspond respectively to photos, audio recordings, text-based messaging, or an image or file from the user's gallery, such as currently stored on their smartphone or computer.

The contribution section 60 may show images 62, text-based messages 63, audio recordings 64, and sponsor ads 65 alongside each other in the grid without differentiating based on the type of message, or users may specify that they prefer to see images, video recordings, audio recordings, or text-based messages separately. For instance, a user may specify that they prefer to see only images or only videos or only text-based messages. The user may engage with one or more of the contributions 62, 63, 64 by hovering over or clicking on the individual contribution of interest, whereupon the interface 50 may instantiate an enlarged view or pop-up window showing that contribution. The user may star the contribution or send a message directly to the contributor. The user may also “save” certain contributions to their profile or to a storage portion of the interface.

When the user clicks one of the icons 61 to make a contribution, an interface 70 may be instantiated. The interface 70 is shown on a screen 71 and includes the menu bar 74 and icons 75. The interface 70 allows the user to continue to view the performance 52 and shows the icons 61. Rather than showing the matrix or grid of contributions as in the interface 50, the interface 70 may allow the user to make a contribution by providing a functionality for taking a photo using the integrated camera and/or microphone of their device, such as a smartphone, or a webcam of a computer. The button 73 allows a user to hold to capture a video and press to capture a photo. The captured video or photo may be shown on the screen 72. Alternatively, the user may wish to enter a text-based message in the screen 72 using the integrated keyboard of their device. Prior to the user adding their contribution using the interface 70, the screen 72 may share an invitation or prompt, such as an invitation relating to the presentation 52. The invitation or prompt may indicate a minimum or maximum length of the contribution and/or a topic of the contribution relating to a storytelling element of the presentation 52.

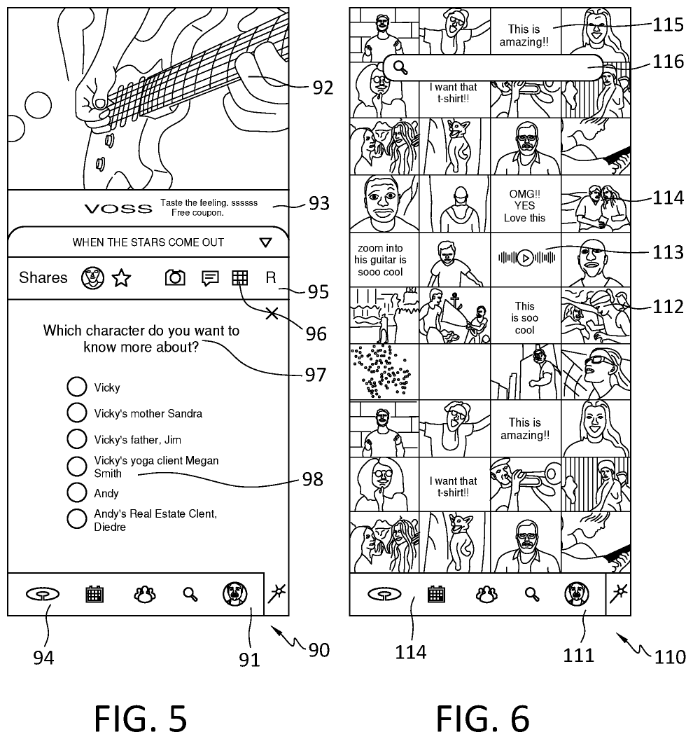

FIG. 5 shows an interface 90 in which a prompt 100 is pushed to a user. While a presentation 92 is ongoing, and a sponsor ad 93 is shown, the prompt 100 may be shown in lieu of a contribution section 95 and associated contribution icons 96 to ask a user a storytelling-related question about the presentation 92. For instance, the prompt 97, which may be pre-determined in a show manager or admin panel of the system, may inquire which of a plurality of characters of a show the user wishes to know more about. The answer may be provided in a multiple-choice format 98. The responses may also be given in short answer form, through audio or video recordings that may be analyzed using a suitable natural language processing model, through images, or otherwise.

The answers to the prompt 97 may be pushed to a show manager or a writer who may adjust the writing process accordingly. For instance, if a plurality or majority of users indicate that they want to know more about the character Vicky, the writers may focus their efforts on developing Vicky's story arc as opposed to another character. This level of feedback is not possible in existing methods for creating content, which rely on one-dimensional ratings for determine how well an audience responds to certain storytelling choices.

FIG. 6 shows a mosaic 100 created from user contributions. An interface 110 on a screen 111 and including a menu bar 114 may include a mosaic 100 of user contributions to a particular performance. The mosaic 100 may comprise text-based messages 115, images 114, audio recordings 113, or video recordings 112. The video and audio recordings and images may be provided in real-time by the user through the interfaces described herein or may be supplied from a gallery on the user's smartphone or computer. The mosaic 100 advantageously provides a user community-generated artwork that reflects an audience's reaction to the performance. The mosaic 100 may be searchable 116.

The mosaic 100 advantageously allows users to connect with a plurality of other users in real-time during a presentation. Whereas in a live concert a user is limited to interacting with a small group of individuals in their immediate vicinity, and whereas in video conferencing modalities like Zoom users are limited to seeing the live video feeds of other users or at most a chat screen of other users rather than contributions like images, text-based messaging, or video or audio recordings, the mosaic 100 provides a dynamic and variegated insight into an audience's reaction and facilitates interaction with specific users. For example, a user may click on or hover over any one contribution of the mosaic 100 and navigate to the contributor's user profile or other contributions. The mosaic 100 further advantageously allows for users to submit such contributions without interrupting the audio and video of the ongoing presentation.

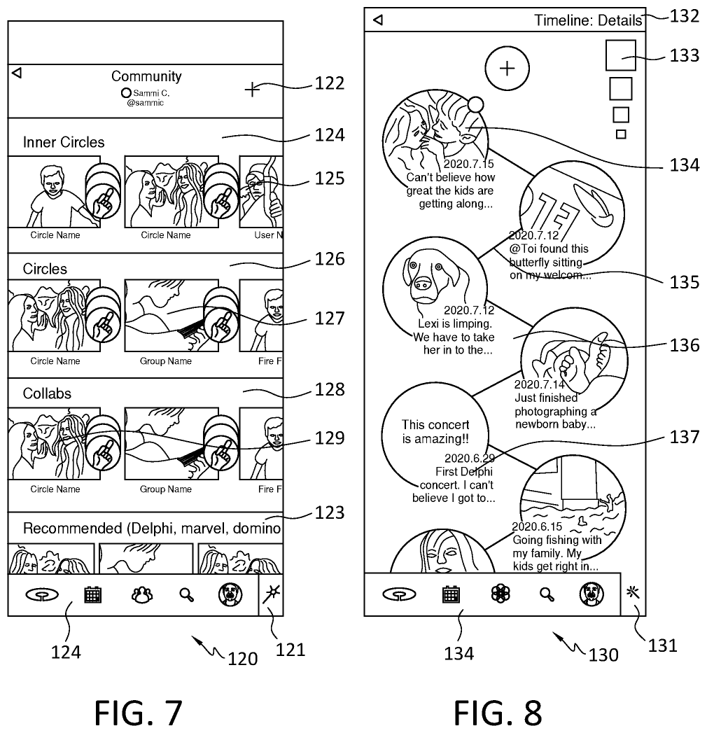

Turning to FIG. 7, a user may navigate to a community interface 120 shown on a screen 121 of the system. The interface 120 may show the menu bar 124 and allow a user to define a community of other users with whom the user chooses to interact. For instance, the interface 120 allows for a user to add 122 a new inner circle, circle, or collaboration of other users. An inner circles section 124, comprising one or more inner circles 125, comprise a group of users with whom the user has connected in response to a performance, performer, starred contribution, or other connection.

The circle section 126 comprising a plurality of circles 127 may define other groups of users with whom the user has connected in response to, for instance, a single performance or contribution. Inner circles 125 may be distinguished from circles 127 on the basis of a frequency or duration of engagement between users and may be determined automatically or manually by a user. For example, a user may designate that a circle 127 should be an inner circle 125 based on the users therein. In other embodiments, the system may automatically generate inner circles 125 from a predefined number, for example 3, of ongoing engagements with other users or proximity to performances.

Collaboration or “collabs” 129 may be shown in a collaborations section 128, which may comprise groups of users with whom the user is collaborating on a creative project with, as will be described in greater detail herein. The system may also recommend circles to the user in a recommended section 123 based on the user's profile, contributions, performances, or otherwise. In embodiments, the system may cooperate with a user's social media accounts (Facebook, Twitter, Instragram, Snapchat, TikTok, etc.) to ascertain interests, friends, and demographic information from which recommended circles may be automatically determined.

A user's timeline may show the user's contributions over a desired timeframe. Turning to FIG. 8, an interface 130 on a screen 131 with a menu bar 134 shows a timeline 132 of contributions from a single user. The timeline 136 may be arranged in a zig-zag format as shown or in any other suitable format. The timeline 136 may include an indicium 132 of a timeframe, such as corresponding to a particular day, week, month, year, performance, genre, or otherwise. The timeline 136 may also include a scale 133 defining individual icons that allow the user to zoom in and out. A larger icon may correspond to a granular day or week view whereas a smaller icon may correspond to a less granular month or year view of contributions.

The timeline 136 may include individual contributions 134 such as images, comments, recordings, or otherwise, connected to adjacent contributions by lines 135. The timeline provides a predetermined number of images and/or characters that the user can view in the timeline 136, from which a user can determine whether to click on or hover over an individual contribution for additional detail. In embodiments, the timeline 136 may facilitate the addition of comments or captions 137 over individual contributions 134. For example, the user may add a comment 137 overlaid onto an image 134 to describe or reflect upon how the user was feeling or what the user was thinking when submitting the contribution. The timeline 136 thereby defines a journal of contributions and reactions to presentations that a user, sponsor, or presenter may review.

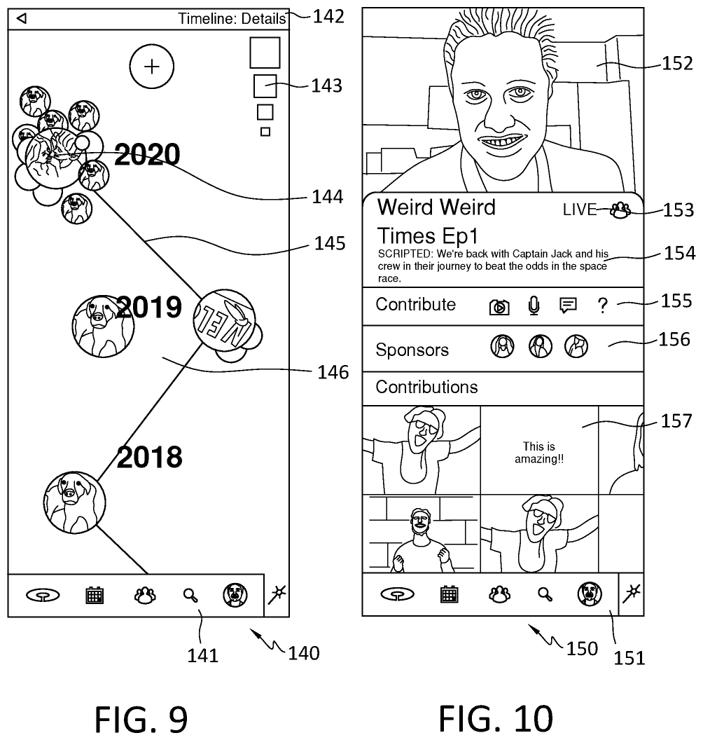

FIG. 9 shows a zoomed-out version of the timeline on an interface 140 on a screen 141. The zoomed-out version of the timeline 146 shows contributions clustered into years 144 connected by lines 145 to adjacent years. The user may rely on the scale 143 to zoom in or zoom out further as desired. The indicium 142 indicates to a user what level of granularity, such as a years view, with which they are observing the timeline 146.

FIG. 10 shows another embodiment of an interface 150 on a screen 151. The interface 150 shows a presentation 152 with an indicium 153 showing whether the presentation is live, previously recorded, or scheduled. A title and/or description 154 may be provided and contributions dashboard 155, sponsors section 156, and contributions section 156 may be provided. The contributions dashboard 155 allows the user to offer a specific type of contribution, the sponsors section 156 allows a user to view and/or navigate to a profile of sponsors of a presentation 152, and the contributions section 156, showing individual contributions 157, allows the user to see how other users are engaging with the presentation. The individual contributions 157 allow the user to connect with like-minded users and view commentary on the presentation in real-time. In embodiments, contributions from other users may be disabled by a user or an admin, such as to prevent spoilers or to focus on the presentation 152.

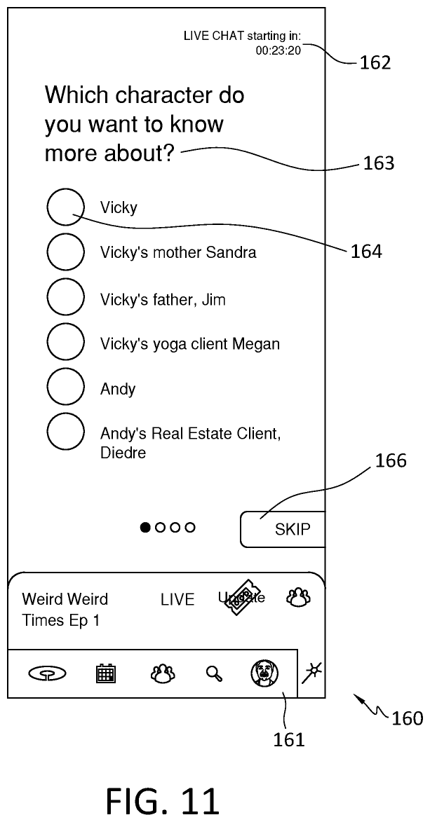

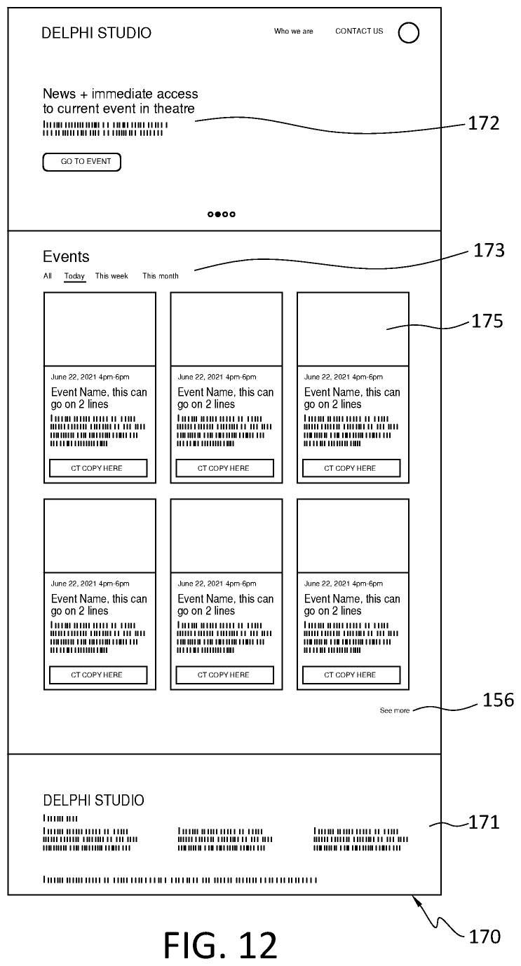

FIG. 11 shows another embodiment of an interface 160 on a screen 161 in which a prompt 163 is automatically shown to a user regarding a presentation, for example immediately following or preceding a presentation. The prompts 163 may be shown during a presentation as well. For example, the prompt 163 may inquire which character the user wants to know more about and may provide a multiple-choice format 164 for responding. The user may skip 166 such prompts and proceed to another presentation or with the current presentation. FIG. 12 shows another embodiment of an interface 170 on a screen 171 in which a selection 173 of events 175 is presented to a user. The interface 170 may include a headliner section 172 including news and/or immediate access to a current event in the system. The events selection 173 may allow the user to toggle between all events, events occurring today, events occurring this week, events occurring this month, events from a particular performer, or otherwise. The user may load another page of events at icon 156.

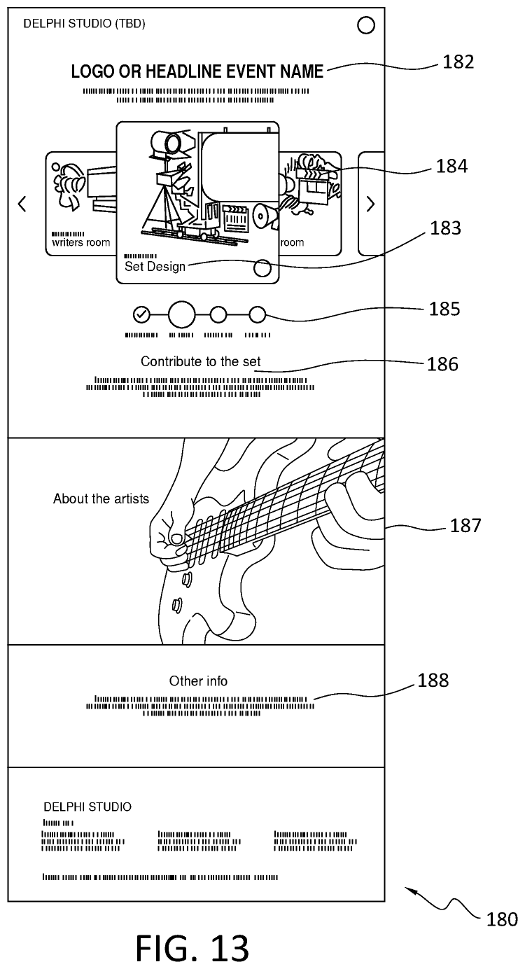

FIG. 13 shows a studio feature of the system and method embodiments. An interface 180 allows a user to access a headliner event or a logo of the system 182, to toggle between studio participation options including set design, writers' room, and sound room 184, to see a selected participation option highlighted or enlarged at 183 and indicated at the scroll 185 and explained at 186. The system offers the user an opportunity to participate in designing and responding to designs about the set, to suggest possible writing choices and to respond to writing decisions in the writers' room, and to participate in sound and music production in the sound room. The interface 180 may show information 187 about artists that the user may wish to collaborate with, as well as other information 187 such as a status of a collaboration.

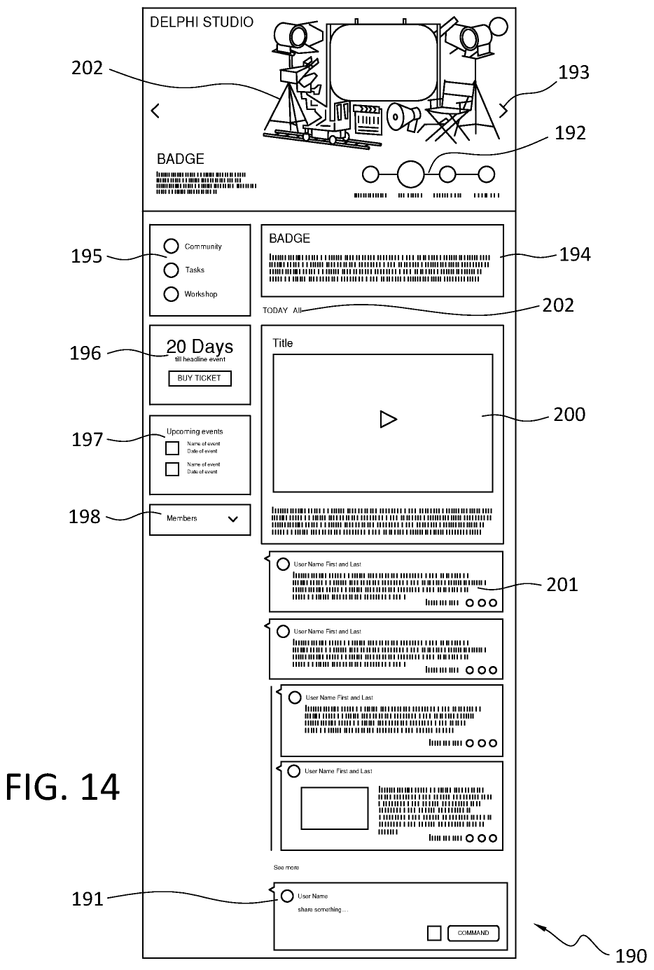

FIG. 14 shows a participation space to which the user may navigate from the interface 180. The interface 190 includes an indicium 202 regarding the participation option, such as set design, as well as a scroll 192 and/or arrow 193 for toggling between, for example, set design, writers' room, and sound room options. The interface may include an indicium 195 about which of a community, tasks, and workshop option the user may select from. In embodiments, the community option may be selected and explained at section 194.

The interface 190 includes an indicium 196 showing how much time remains for collaboration, an indicium 197 regarding upcoming events 197, an indicium 198 such as a drop-down menu regarding members of the participation space, a screen 200 whereat the current progress may be shown, such as through a video playback, a comment area 201 where members of the participation space may share ideas or feedback and receive stars or replies from other users or the performer, and an option 202 for selecting today's comments or all comments. A message portal 191 allows a user to submit comments, feedback, photos, or otherwise for view by the other members. While the interface 190 is shown regarding set design, the community space shown in the interface 190 may apply as well to the writers' room and sound room spaces.

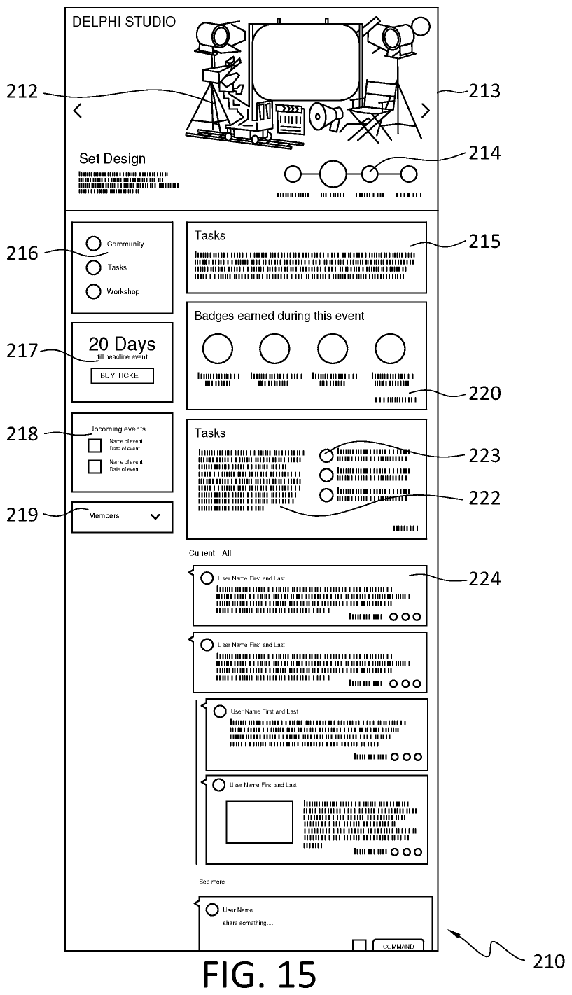

FIG. 15 shows an interface 210 corresponding to a tasks option of a particular participation option such as set design. The interface 210 includes an indicium 210 regarding the participation option, such as set design, as well as a scroll 214 and/or arrow 213 for toggling between, for example, set design, writers' room, and sound room options.

The interface 210 may further include an indicium 216 about which of a community, tasks, and workshop option the user may select from. In embodiments, the community option may be selected and explained at section 215. The interface 210 includes an indicium 217 showing how much time remains for collaboration, an indicium 218 regarding upcoming events, an indicium 219 such as a drop-down menu regarding members of the participation space, a space 220 where badges earned by one or more users in the space may be displayed, a space 222 for tasks that remain to be completed and indicators 223 of the status of said tasks, and ongoing comments 224, which may be nested, regarding the tasks. While the interface 190 is shown regarding set design, the community space shown in the interface 190 may apply as well to the writers' room and sound room spaces.

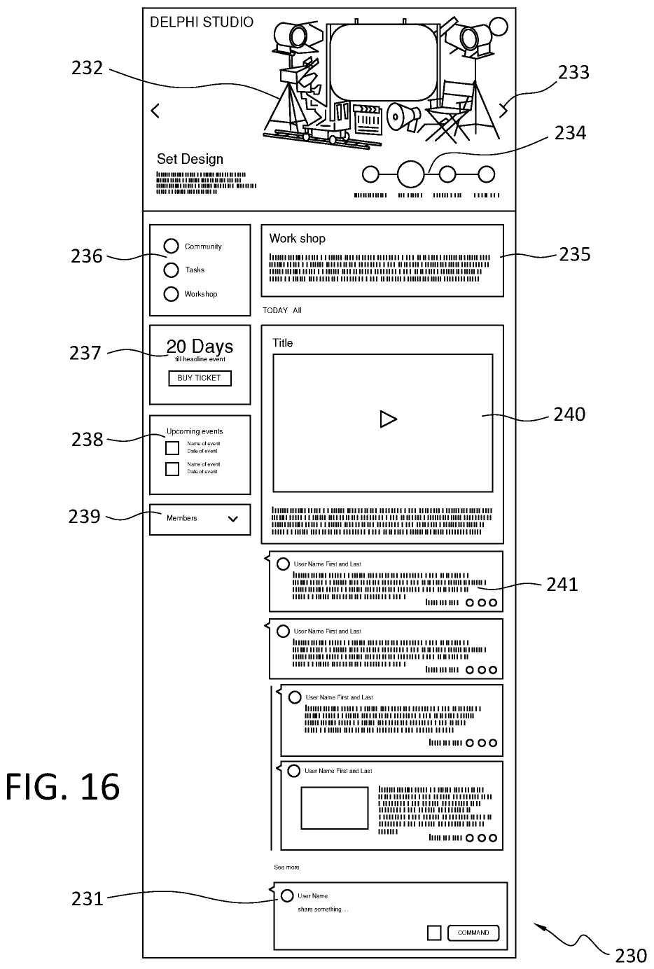

FIG. 16 shows an interface 230 corresponding to a workshop option of a particular participation option such as set design. The interface 230 includes an indicium 232 regarding the participation option, such as set design, as well as a scroll 234 and/or arrow 233 for toggling between, for example, set design, writers' room, and sound room options.

The interface 230 may further include an indicium 236 about which of a community, tasks, and workshop option the user may select from. In embodiments, the workshop option may be selected and explained at section 235. The interface 230 includes an indicium 237 showing how much time remains for collaboration, an indicium 238 regarding upcoming events, an indicium 239 such as a drop-down menu regarding members of the participation space, a space 240 where a video playback such as from an artist or a user may be displayed, and/or a space 241 for ideas to be generated, critiqued, expanded upon, or otherwise. A message or contribution portal 231 allows the user to contribute to the ideas.

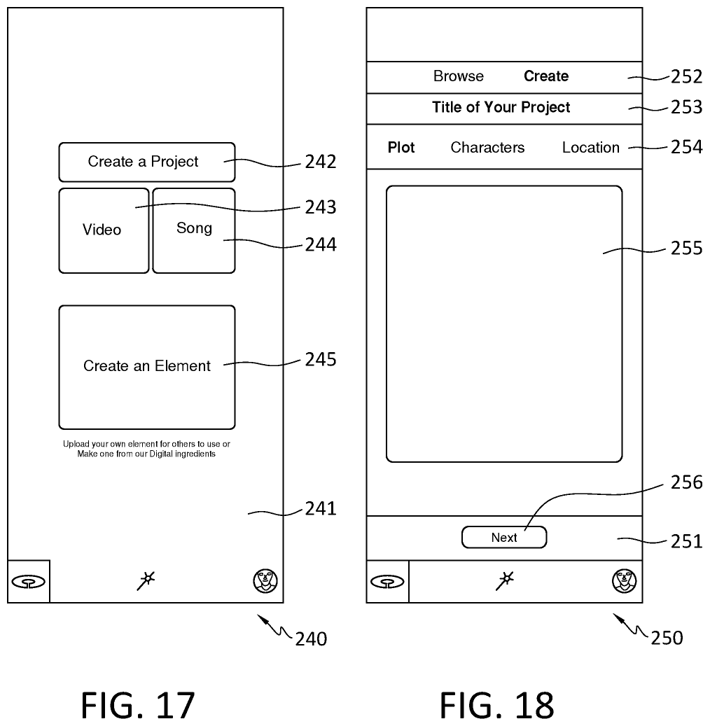

FIG. 17 shows a creation space of the system. The interface 240 on the screen 241 allows a user to create a project 242, such as a video 243 or a song 244, or an element 245. FIG. 18 shows an interface 250 on screen 251 in which the user may toggle between browse and create modes 252, add a title 253, and toggle between plot, characters, location, or otherwise 254. The interface 250 provides a space 255 where text may be added by a user, and a button 256 to navigate further.

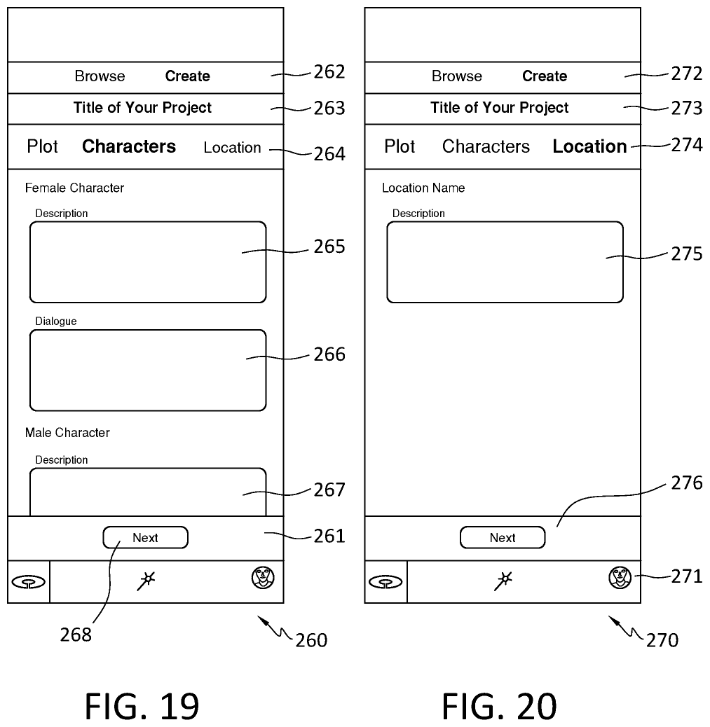

FIG. 19 shows an interface 260 on a screen 261 in which the user, having added for example a plot description in the interface 250, may add character information 264. The user may, for a female character, add a description 265 and/or a dialogue 266, and for a male character add a description 267 and/or a dialogue, before progressing 268. FIG. 20 shows an interface 270 in which a location 274 may be added, particularly a description 275, before progressing 276. In any of the above embodiments, an image, a voice or video recording, or other submission may also be used.

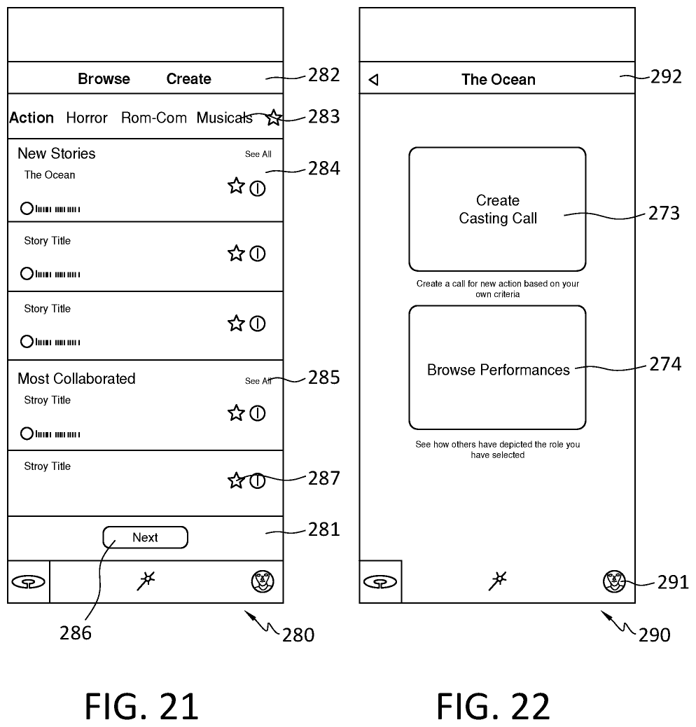

FIG. 21 shows a browse function 282 of an interface 280 on a screen 281 in which a user may browse existing stories according to a genre 283, such as action, horror, rom-com, musicals, drama, or otherwise, with the individual selections 284 listed for the user to peruse. The user may star or flag one or more of the selections 284. The interface 280 may provide indicia 285 regarding selections 284 that are most collaborated on, most starred, or otherwise. After progressing 286, the user may see on an interface 290 on a screen 291 details of a particular selection, which may have been prepared according to the embodiments and method of FIGS. 18-20. The selection may have a title 292 and may allow for collaboration, such as by creating a casting call 273 or browsing existing performances 274 by other users in a library.

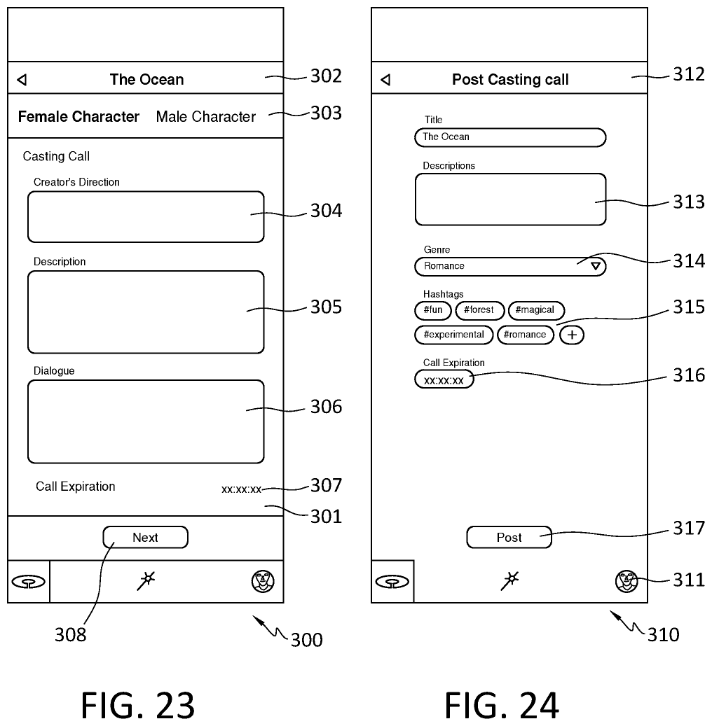

Turning to FIG. 23, the casting call option may be detailed in the interface 300 on a screen 301, where a user may see the title 302, toggle between characters 303 for whom to detail the casting call, and add direction 304, description 305, and dialogue 306, respectively. An expiration date 307 may be specified for the casting call. Turning to FIG. 24, the casting call may be posted or submitted to users of the system in the interface 310 on the screen 311. The interface may have a header 312 regarding the task of posting the casting call, allowing the user to specify a description 313 of the casting call, specify a genre 314, add hashtags 315 or other metadata, and specify or modify the expiration date 316, before posting at 317.

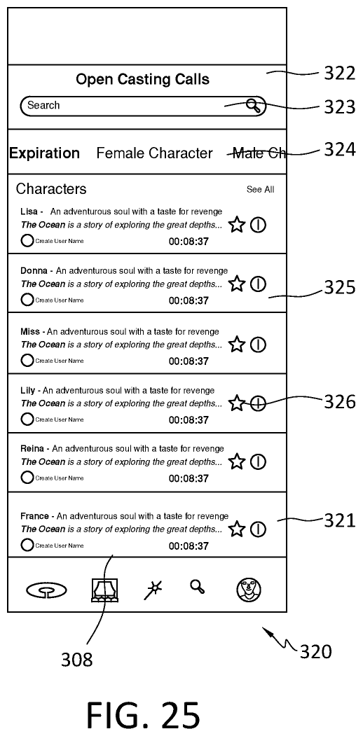

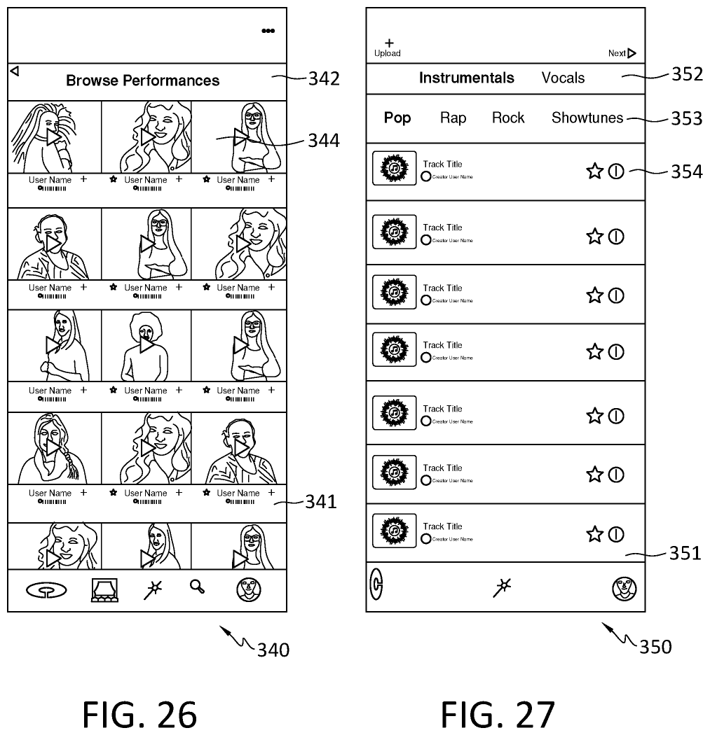

Turning to FIG. 25, a user using interface 320 on screen 321 may browse open casting calls 322 by using a search function 323 or by toggling 324 between expiration dates, female characters, male characters, genres, or otherwise. Individual open casting calls 325 may be displayed in a list or matrix, which the user can flag or star 326 as necessary. By starring the open casting calls 325, the user may save these in their profile for review later. Turning to FIG. 26, an interface 340 on a screen 341 allows a user to browse performances 342, where individual performances 344, which may comprise video recordings, may be arranged in a listing, a grid, or any other suitable manner. The performances 342 may be submitted in response to the casting call of FIG. 24.

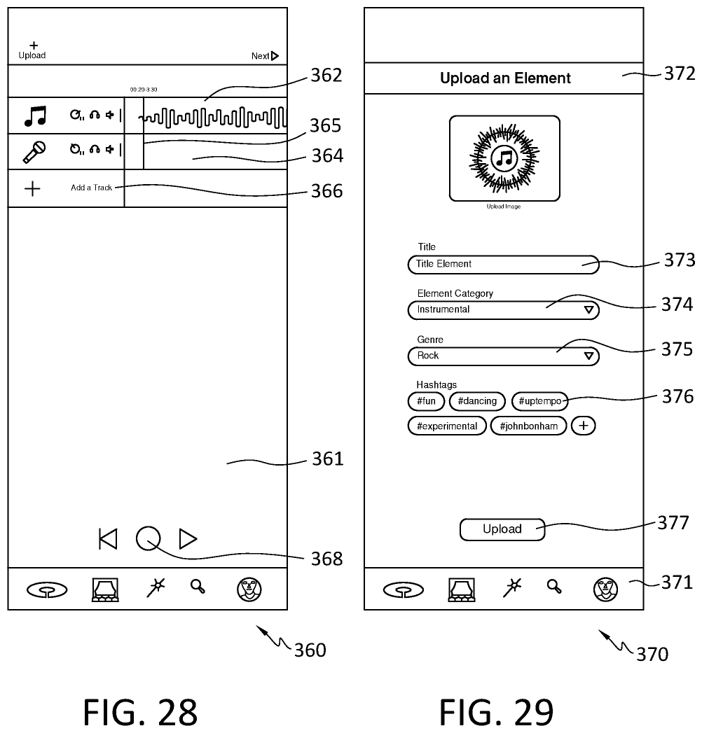

FIGS. 27-29 shows an interface for a user to create music, including instrumentals, vocals, effects, and otherwise, for a collaborative project. The interface 350 of FIG. 27 includes a screen 351 and allows a user to toggle 352 between instrumentals and vocals, between genres 353, and to browse available listings 354. The selected track may be added to the interface 360 of FIG. 28, as track 362, to which the user may add additional tracks 364, 366. The selected track 362 may be an instrumental track to which the user may add a custom vocal track 364 by using the recording function 368. A status bar 365 allows the user to see the progress of their vocal track against the existing instrumental track 362. Additional tracks 366 may be added. These may include effects through which the user may browse, additional instrumental effects, or otherwise.

For example, in the interface 370 of FIG. 29, the user may select or upload an element, such as a finished audio project as per FIGS. 27 and 28. The user may provide a title 373, a category 374, a genre 375, one or more hashtags 376, and upload 377. The projects completed through the interface may be accessible through or stored in the user's profile.

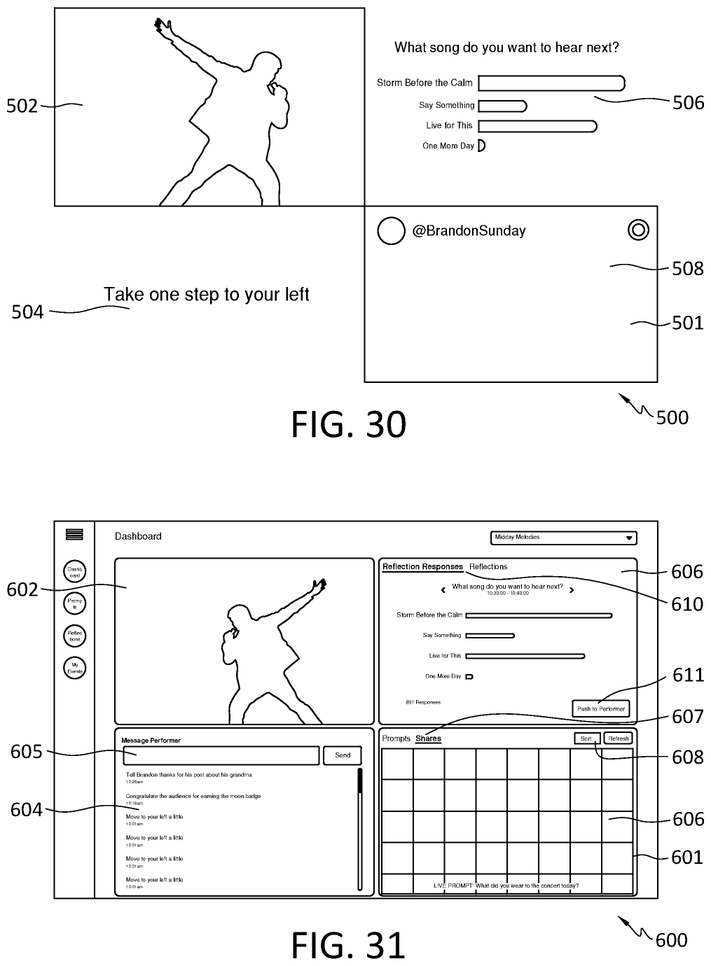

Turning to FIG. 30, a performer panel of the system is shown. The performer panel is an interface 500 that the performer has access to during the performance. The performer panel 500 may be minimized compared to the show manager panel of FIG. 31 to minimize distractions to the performer. The performer panel 500 may include a screen 502 showing the performer their position relative to a field of view of the camera they are using. A module 504 includes messages pushed to the performer from a show manager, such as instructions regarding repositioning within the field of view. A module 506 includes results from a question, such as what song users would like to hear next. The winning selection may be highlighted and/or enlarged for easy viewing. A module 508 may include a single contribution that the show manager or the system pushes to the performer. For instance, the module 508 may show a username associated with the contribution so that the performer can give the user a shout-out during the performance. The system may automatically push a most-starred contribution to the module 508, allowing the performer to see what messages, images, or otherwise the users are most responsive to at any given moment.

Turning to FIG. 31, a show manager panel of the system is shown, defining an interface 600 on a screen 601 that a show manager may have access to during the performance. The show manager may have a module 602 showing the performer within the field of view of the camera and a message portal 604, where the manager may see a message history and type new messages 605, with the option to send or push a message to the performer. In embodiments, the message portal may show which message is currently visible to the performer. A module 606 allows the show manager to see reflections by users. For example, the show manager may toggle 610 between reflections, i.e. questions to the users, and reflection responses from the users in response to the questions. An option 611 allows the show manager to push the response to a performer, such as by showing a graphical representation of users' responses. The show manager may also toggle between different responses.

A module 608 allows the show manager to view contributions by users in real-time. The module 608 may allow the show manager to toggle 607 between prompts and shares. The show manager may select 608 a contribution to be pushed to the performer, such as a particularly popular contribution or an individual user for the performer to give a shout-out to.

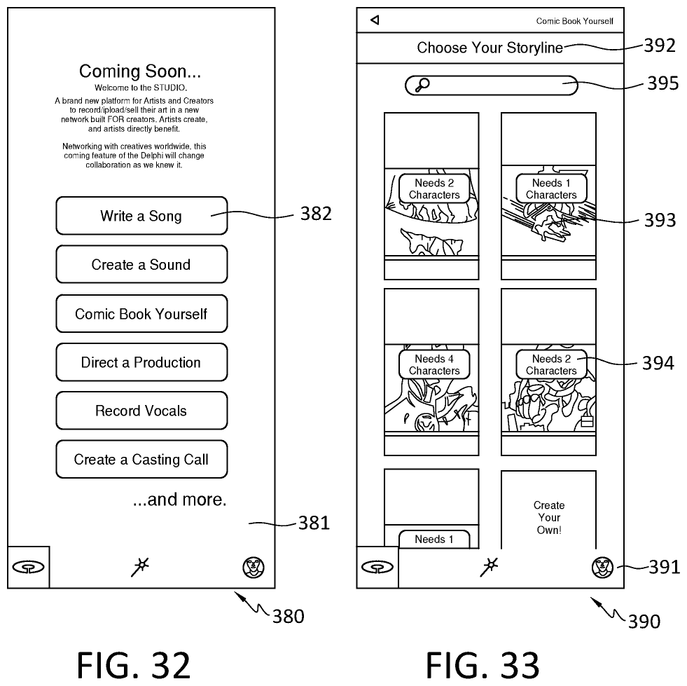

Turning to FIG. 32, a component of the studio of the system allows users to create custom projects. An interface 380 allows the user to write a song, create a sound, or comic book themselves, direct a production, record vocals, creating casting calls, and other projects. The interface 390 of FIG. 33 allows a user to comic book themselves by starting with a storyline 392, which may be searched at 395. Available storylines 393 may be shown in a list or grid and may indicate at 394 how many characters will need to be created by the user.

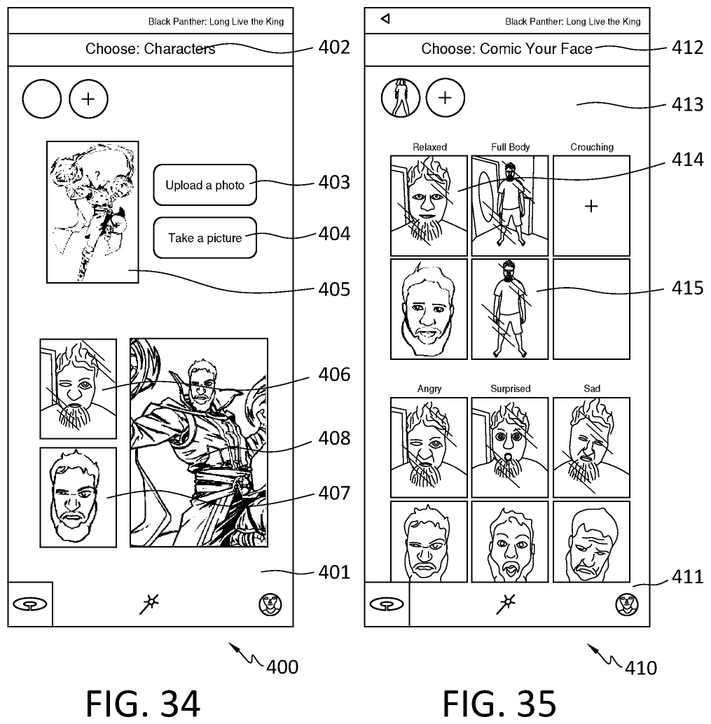

Turning to FIG. 34, the user may select characters 402 through the interface 400 by uploading photos 403, taking a photo 404, and modifying a photo against an existing template 405. The user's photo 406 may be abstracted using a suitable filter or model at 407 to an animated version, and then appended at 408 to the template 405. Likewise at FIG. 35, the user may be directed by an interface 410 at 412 for a particular character to upload images corresponding to poses or emotions needed for the selected storyline, which may include relaxed, full body, crouching, angry, surprised, and/or sad faces or poses. This list is merely exemplary and any suitable pose, emotion, action, or otherwise may be designated by the system. The user may upload and review images 414 which are abstracted by the system to an animated version 415.

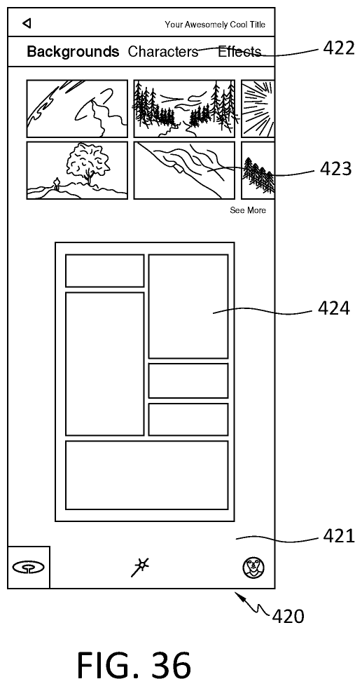

Turning to FIG. 36, in embodiments in which a user is comic-booking themselves, an interface 420 allows the user to add or select from 422 background, characters, effects, or otherwise. Samples 423 may be shown and selected. These may be added to a tile template 424. The method and system of FIGS. 32-36 advantageously allows user to create custom projects, alone or in combination/collaboration with other users, in an intuitive and flexible manner. These projects may be made available by the user in a marketplace of the system, allowing the user to receive a percentage of revenue when their projects are used. While music and comic books have been shown and described, it will be appreciated that the present disclosure extends further to backgrounds, vocal tracks, drumbeats, special effects, and any other creative contributions that a user may supply.

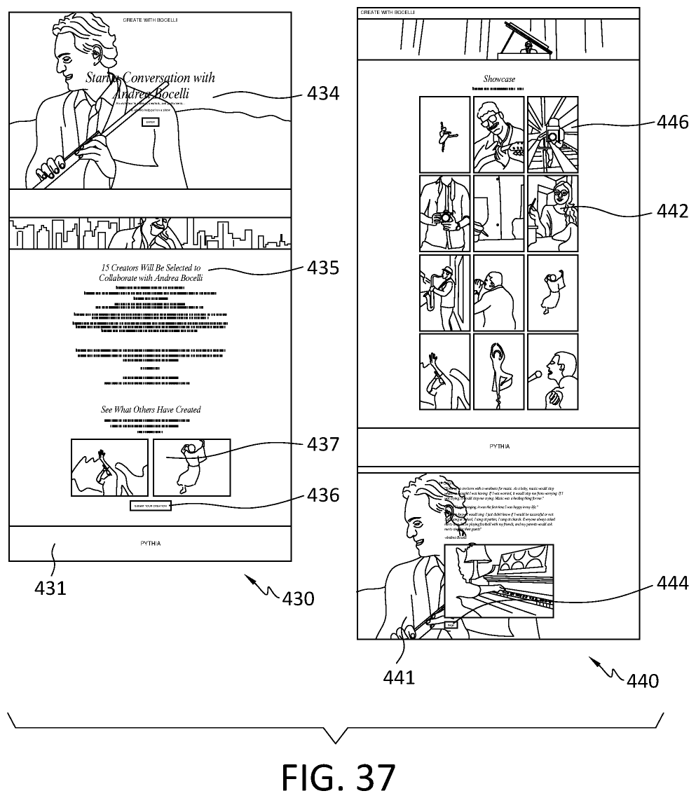

FIG. 37 shows an interface of a community page according to the system and method embodiments. The interface 430, 440 may include a space for collaborating with a particular performer. In an embodiment, the interface includes a headliner 434 detailing a performer with whom the users are invited to co-create. The interface 430 may include details 435 of what the user may submit and what projects the performer is inviting users to participate in. A sample 437 of contributions by other users is shown and the user may enter the creative space through a portal 436. Within the space shown in interface 440, certain individual contributions 432 may be showcased 446. The user can then proceed with the system and method of co-creating described herein, such as by providing images, videos, audio recordings, text-based messaging, or other contributions as solicited, and may respond to contributions of others, including questions from the performer. This allows the user to have a say in the creative direction of a performance and allows the performer to get real-time, pre-performance input on creative decisions.

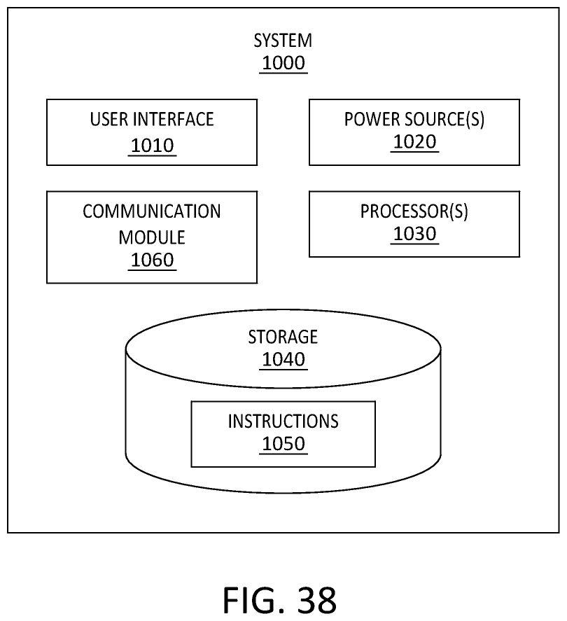

FIG. 38 depicts a computer system 1000 on which the system and method for bi-directional communication for performances may be housed and performed. The computer system 1000 may comprise storage 1040, processor(s) 1030, I/O interfaces 1010, a power source 1020, a communication module 1060, and instructions 1050 such that when the processor(s) 1030 executes the instructions 1050, the system 1000 performs the methods described herein.

The storage 1040 may comprise instructions 1050 for operating a system and method for bi-directional communication for performances stored thereon in a non-transitory form that, when executed by the processor 1030, cause the processor 1030 to carry out one or more of the steps described herein, such as providing an interface to a user, receiving performance data, such as a video and audio stream, from a presenter, displaying the performance data to the user, presenting one or more prompts, receiving feedback or contributions from the user, and displaying the feedback or contributions from the user to the presenter and/or to other users. The instructions 1050 may cause the processor 1030 to generate a mosaic of user contributions defining a real-time response to the presenter, the mosaic comprising one or more of audio and video recordings, images, text-based messaging, or other contributions, and may organize the contributions chronologically, by popularity, or otherwise.

Embodiments of the present disclosure may comprise or utilize a special-purpose or general-purpose computer system that includes computer hardware, such as, for example, one or more processors and system memory, as discussed in greater detail below. Embodiments within the scope of the present disclosure also include physical and other computer-readable media for carrying or storing computer-executable instructions and/or data structures.

Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” may be defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions may comprise, for example, instructions and data which, when executed by one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The disclosure of the present application may be practiced in network computing environments with many types of computer system configurations, including, but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The disclosure of the present application may also be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

By providing a method and system for bi-directional communication for performances, a deeper and more meaningful connection between individuals may be fostered. A digital creation space may be provided to solicit narrative data in response to a predetermined narrative structure, the narrative data being stored, processed, and transformed in advantageous and unconventional ways to provide an emotional profile that can reveal intertwined storylines in the revealing context of the predetermined narrative structure. The intertwined storylines allow for an intelligent connection between individuals, with insights provided on the meaningful life experiences driving engagement with particular elements of a narrative.

It is to be understood that not necessarily all objects or advantages may be achieved under any embodiment of the disclosure. Those skilled in the art will recognize that the system and method for bi-directional communication for performances may be embodied or carried out in a manner that achieves or optimizes one advantage or group of advantages as taught herein without achieving other objects or advantages as taught or suggested herein.

The skilled artisan will recognize the interchangeability of various disclosed features. Besides the variations described herein, other known equivalents for each feature can be mixed and matched by one of ordinary skill in this art to build and use a system and method for bi-directional communication for performances under principles of the present disclosure. It will be understood by the skilled artisan that the features described herein may be adapted to other methods and types of communication systems. While certain story acts and story patterns are arcs are described, said acts and arcs are exemplary are not intended to be limiting. Other acts of a story and other story patterns or arcs are envisioned.

Although this disclosure describes certain exemplary embodiments and examples of a system and method for bi-directional communication for performances, it will be understood by those skilled in the art that the present disclosure extends beyond the specifically disclosed system and method for bi-directional communication for performances to other alternative embodiments and/or uses of the disclosure and obvious modifications and equivalents thereof, including other types of information obtained in other types of contexts. It is intended that the present disclosure should not be limited by the disclosed embodiments described above and may be extended to other applications that may employ the features described herein.

1. A system for bi-directional communication for performances, comprising:
at least one user device; and
a performance server in network communication with the at least one user device through a communications interface, the performance server comprising a memory and a processor configured for executing instructions stored on the memory to provide a user interface to the at least one user device;
wherein the user interface is configured to display a performance to at least one user device and to receive at least one response from the at least one user device;
wherein the user interface is configured to incorporate the at least one response into the display of the performance.

2. The system of claim 1, wherein the performance server is configured to receive at least one response from a plurality of user devices.

3. The system of claim 1, wherein the performance server is configured to receive at least one response from a plurality of user devices and to define a mosaic from the responses.

4. The system of claim 3, wherein the mosaic comprises a combination of at least a portion of the responses, said responses comprising one or more of video recordings, audio recordings, images, and text-based messages.

5. The system of claim 3, wherein the user interface is configured to display the mosaic behind a performer in the performance.

6. The system of claim 5, wherein the system further comprises a green screen in front of which the performer conducts the performance and a camera capturing the performance.

7. The system of claim 3, wherein the responses included in the mosaic are selected automatically by the system.

8. The system of claim 3, wherein the responses are selected chronologically and form part of the mosaic for a predetermined period of time.

9. The system of claim 3, wherein the responses are arranged in a grid or matrix to define the mosaic.

10. The system of claim 3, wherein the responses defining the mosaic are replaced with new responses from the at least one user devices.

11. The system of claim 3, wherein the responses are selected to include a sponsor response.

12. The system of claim 3, wherein the performance server provides at least one prompt to the plurality of user devices;
wherein the responses are received in response to the at least one prompt.

13. The system of claim 12, wherein the at least one prompt is predetermined by the performer.

14. The system of claim 12, wherein the system is configured to transmit the responses to the performer in real-time.

15. The system of claim 12, wherein the at least one prompt is directed to a storytelling act corresponding to the performance.

16. A hardware storage device having stored thereon computer executable instructions which, when executed by one or more processors of a computer system, configure the computer system to perform at least the following:
transmit a performance to at least one user;
receive at least one response from the at least one user;
transmit the at least one response from the at least one user to a performer; and
combine the performance and the at least one response for display in a user interface.

17. A method for bi-directional communication for performances, the method comprising the steps:
receiving a performance from at least one performer;
transmitting the performance to at least one user;
receiving at least one response from the at least one user;
transmitting the response to the performer in real-time.

18. The method for bi-directional communication for performances of claim 17, the method further comprising the steps:
creating a mosaic from a plurality of responses, the plurality of responses comprising at least one response from a plurality of users including the at least one user; and
displaying the mosaic as part of the performance.

19. The method for bi-directional communication for performances of claim 18, wherein the mosaic defines a grid of the plurality of responses comprising one or more of images, video recordings, audio recordings, and/or text-based messaging.

20. The method for bi-directional communication for performances of claim 17, further comprising the step of automatically arranging the grid of responses on a basis of popularity of the plurality of responses.
